(19) United States
(12) Patent Application Publication
(10) Pub. No.: US 2005/0090587 A1
(43) Pub. Date: Apr. 28, 2005

(54) Ultraviolet light stability of monovinylarene-conjugated diene copolymer compositions

(76) Inventor: John E. Dunn, Bartlesville, OK (US)

Correspondence Address: WILLIAMS, MORGAN & AMERSON, P.C., 10333 RICHMOND, SUITE 1100, HOUSTON, TX, 77042, US

(21) Appl. No.: 10/695,204

(22) Filed: Oct. 28, 2003

(51) Int. Cl. C08L 1/00

(52) U.S. Cl. 524/106; 524/86; 524/89; 524/571; 524/577; 524/579

(57) ABSTRACT

We disclose a composition, comprising at least about 5 wt % of a monovinylarene-conjugated diene copolymer; from about 0.1 wt % to about 2.5 wt % of an ultraviolet (UV) absorber; and from about 0.1 wt % to about 2.5 wt % of a light stabilizer. This composition imparts UV stability to monovinylarene-conjugated diene copolymer compositions and articles made therefrom.

### BACKGROUND OF THE INVENTION

The present invention relates generally to the fields of polymer chemistry. More particularly, it concerns monovinylarene-conjugated diene copolymer compositions which are UV-stabilized by the inclusion of UV absorbers and light stabilizers.

Articles formed from monovinylarene-conjugated diene copolymers, such as styrene-butadiene copolymers, for example K-Resin® (Chevron Phillips Chemical Co., The Woodlands, Tex.), have good durability, clarity, and impact strength. However, monovinylarene-conjugated diene copolymers typically have relatively high absorbance of ultraviolet light (UV) in the wavelength range of about 200 nm to about 400 nm, particularly at about 200 nm to about 300 nm. Thus, they are generally unstable on long-term exposure to ultraviolet light (UV), leading to discoloration, particularly yellowing, of articles made therefrom. Where UV stability of an article is desired, the skilled artisan has heretofore typically turned to polycarbonates, acrylics, copolyesters, and cellulosics for the formation of such articles.

However, the skilled artisan would welcome the introduction of a polymer composition having both the physical properties of monovinylarene-conjugated diene copolymers and the UV stability seen in polycarbonates, acrylics, copolyesters, and cellulosics.

### SUMMARY OF THE INVENTION

In one embodiment, the present invention relates to a composition, comprising (i) at least about 5 wt % of a monovinylarene-conjugated diene copolymer; (ii) from about 0.1 wt % to about 2.5 wt % of an ultraviolet (UV) absorber; and (iii) from about 0.1 wt % to about 2.5 wt % of a light stabilizer.

In another embodiment, the present invention relates to a method of synthesizing a UV-stabilized monovinylarene-conjugated diene copolymer composition, comprising combining (i) at least about 5 wt % of a monovinylarene-conjugated diene copolymer; (ii) from about 0.1 wt % to about 2.5 wt % of an UV absorber; and (iii) from about 0.1 wt % to about 2.5 wt % of a light stabilizer, to form the composition.

In a further embodiment, the present invention relates to a method of fabricating a UV-stabilized monovinylarene-conjugated diene copolymer article, comprising:
forming a composition, as described above, into the article or a component thereof.

Articles formed from the composition of the present invention exhibit UV stabilization generally superior to that seen for compositions consisting of monovinylarene-conjugated diene copolymers and comparable to that seen for polycarbonates, a class of polymers generally considered to have commercially acceptable UV stabilization.

### DESCRIPTION OF ILLUSTRATIVE EMBODIMENTS

In one embodiment, the present invention relates to a composition, comprising (i) at least about 5 wt % of a monovinylarene-conjugated diene copolymer; (ii) from about 0.1 wt % to about 2.5 wt % of an ultraviolet (UV) absorber; and (iii) from about 0.1 wt % to about 2.5 wt % of a light stabilizer.

“Conjugated diene,” as used herein, refers to an organic compound containing conjugated carbon-carbon double bonds and a total of 4 to 12 carbon atoms, such as 4 to 8 carbon atoms. Exemplary conjugated dienes include, but are not limited to, 1,3-butadiene, 2-methyl-1,3-butadiene, 2-ethyl-1,3-butadiene, 2,3-dimethyl-1,3-butadiene, 1,3-pentadiene, 3-butyl-1,3-octadiene, and mixtures thereof. In one embodiment, the conjugated diene can be 1,3-butadiene or isoprene. A unit of polymer, wherein the unit is derived from polymerization of a conjugate diene monomer, is a “conjugated diene unit.”

Unless a particular use is specified to the contrary, the word “or” is used herein in the inclusive sense; that is, if at least one of the conditions linked by “or” is true, a statement reciting those conditions is within the scope of the present disclosure and claims.

“Monovinylarene,” as used herein, refers to an organic compound containing a single carbon-carbon double bond, at least one aromatic moiety, and a total of 8 to 18 carbon atoms, such as 8 to 12 carbon atoms. Exemplary monovinylarenes include, but are not limited to, styrene, alpha-methylstyrene, 2-methylstyrene, 3-methylstyrene, 4-methylstyrene, 2-ethylstyrene, 3-ethylstyrene, 4-ethylstyrene, 4-n-propylstyrene, 4-t-butylstyrene, 2,4-dimethylstyrene, 4-cyclohexylstyrene, 4-decylstyrene, 2-ethyl-4-benzylstyrene, 4-(4-phenyl-n-butyl)styrene, 1-vinylnaphthalene, 2-vinylnaphthalene, and mixtures thereof. In one embodiment, the monovinylarene is styrene. A unit of polymer, wherein the unit is derived from polymerization of a monovinylarene monomer, is a “monovinylarene unit.”

Any monovinylarene-conjugated diene copolymer can be a component of the composition. In one embodiment, the monovinylarene-conjugated diene copolymer is a block copolymer comprising styrene blocks and butadiene blocks (a “styrene-butadiene copolymer”). An exemplary styrene-butadiene copolymer is commercially available under the name K-Resin® (Chevron Phillips Chemical Co., The Woodlands, Tex.).

As stated above, the composition comprises at least about 5 wt % of the monovinylarene-conjugated diene copolymer, such as between about 5 wt % and 50 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, or at least about 95 wt %, among other possible levels. All wt % given herein are by total weight of the composition.

In one embodiment, the balance of the composition (i.e., all components other than the UV absorber and the light stabilizer) consists of the monovinylarene-conjugated diene copolymer. In another embodiment, the balance of the composition comprises the monovinylarene-conjugated diene copolymer.

A UV absorber, as used herein, can be a compound capable of absorbing electromagnetic radiation having a wavelength between about 10 nm and about 400 nm. In one embodiment, the UV absorber has a molar extinction coefficient ε (epsilon) of at least 1000 l/mol cm in an apolar organic solution at at least one wavelength between about 250 nm and about 350 nm. In one embodiment, the UV absorber has a molar extinction coefficient ε (epsilon) of at least 5000 l/mol cm in an apolar organic solution at at least one wavelength between about 250 nm and about 350 nm. The apolar organic solution can comprise, by way of example, chloroform, acetone, or cyclohexane, among others

In one embodiment, the UV absorber comprises a phenol group and a triazol or triazin group.

In a further embodiment, the UV absorber is 2-(2H-benzotriazol-2-yl)-4,6-ditertpentylphenol or 2-(4,6-diphenyl-1,3,5-triazin-2-yl)-5-(hexyl)oxylphenol. 2-(2H-benzotriazol-2-yl)-4,6-ditertpentylphenol is commercially available as Tinuvin 328 (Ciba Specialty Chemicals, Basel, Switzerland). 2-(4,6-diphenyl-1,3,5-triazin-2-yl)-5-(hexyl)oxylphenol is commercially available as Tinuvin 1577 (Ciba Specialty Chemicals, Basel, Switzerland).

Tinuvin 328 exhibits strong absorbance at UV wavelengths from 300 nm to about 400 nm and minimal absorbance in the visible wavelength range (greater than about 400 nm). It has absorption maxima at 306 nm and 347 nm in chloroform solution. Its molar extinction coefficient ε (epsilon) is about 14,760 l/mol cm at 347 nm in chloroform solution.

Tinuvin 1577 exhibits strong absorbance at UV wavelengths from 300 nm to about 400 nm and minimal absorbance in the visible wavelength range (greater than about 400 nm). It has absorption maxima at 274 nm and 341 nm in chloroform solution. Its molar extinction coefficient ε (epsilon) is about 22,000 l/mol cm at 341 nm in chloroform solution.

Other UV absorbers, including other benzotriazol UV absorbers, are known, such as Tinuvin P (a relatively low molecular weight benzotriazol), among others, including relatively high molecular weight benzotriazols. Tinuvin P is commercially available from Ciba Specialty Chemicals (Basel, Switzerland).

As stated above, the UV absorber is present from about 0.1 wt % to about 2.5 wt % of the composition. In one embodiment, the UV absorber is present from about 0.3 wt % to about 0.6 wt % of the composition. Higher concentrations of UV absorbers may help impart a slightly higher UV resistance to articles formed from the composition, but at a higher cost in materials. Determining the particular concentration of the UV absorber is a matter of routine experimentation for the skilled artisan having the benefit of the present disclosure.

A light stabilizer, as used herein, is a compound which imparts greater resistance to light-induced damage in a composition than is seen for a reference composition which does not include the light stabilizer but is otherwise identical to the composition. A hindered amine light stabilizer, or HALS, as used herein, is a light stabilizer which is also a compound comprising one or more NR₃ moieties, wherein each R is independently hydrogen or tertiary carbon, provided at least two R are tertiary carbons. “Tertiary carbon” has its standard meaning of a carbon atom bonded to three other carbon atoms. The other carbon atoms can be subsequently bonded to carbon, hydrogen, oxygen, nitrogen, sulfur, or other atoms known in the art to be found in organic molecules.

In one embodiment, the HALS comprises bis(1,2,2,6,6-pentamethyl-4-pipderidyl)sebacate or methyl 1,2,2,6,6-pentamethyl-4-pipderidyl sebacate. A HALS comprising both of the above is commercially available as Tinuvin 765 (Ciba Specialty Chemicals, Basel, Switzerland).

As stated above, the composition comprises from about 0.1 wt % to about 2.5 wt % light stabilizer. In one embodiment, the light stabilizer is present from about 0.4 wt % to about 0.6 wt % of the composition. Higher concentrations of light stabilizer may help impart a slightly higher UV resistance to articles formed from the composition, but at a higher cost in materials. Determining the particular concentration of the light stabilizer is a matter of routine experimentation for the skilled artisan having the benefit of the present disclosure.

Typically, the composition is homogeneous, but it need not be.

In addition to the UV stabilizer and the light stabilizer, the composition can further comprise other additives useful in the processing, storage, formulation, or use of the composition or articles formed therefrom. Examples of such additives include, but are not limited to, other polymers, microcrystalline wax, crystal styrene, and blue or violet tint, among others. Particular additives and levels thereof for inclusion in the composition can be determined as a matter of routine experimentation by the skilled artisan having the benefit of the present specification. Other polymers that can be included in the composition include, but are not limited to, styrene/methyl methacrylate or polystyrene, among others apparent to the skilled artisan as a matter of routine experimentation. Blue or violet tint may provide a benefit by further reducing yellowing in a structure made from the composition.

In another embodiment, the present invention relates to a method of synthesizing a UV-stabilized monovinylarene-conjugated diene copolymer composition, comprising:
combining (i) at least about 5 wt % of a monovinylarene-conjugated diene copolymer; (ii) from about 0.1 wt % to about 2.5 wt % of an ultraviolet (UV) absorber; and (iii) from about 0.1 wt % to about 2.5 wt % of a light stabilizer, to form the composition.

The term “UV-stabilized” means that the composition exhibits yellowing resistance on exposure to UV, relative to a composition consisting of the monovinylarene-conjugated diene copolymer referred to as component (i) of the composition. Yellowing resistance can be measured by any appropriate technique, such as a difference in Hunter b values as measured in a colorimeter, by the skilled artisan having the benefit of the present disclosure. The compositions to be tested in the colorimeter can be aged naturally or undergo accelerated aging in a weatherometer, if desired.

The monovinylarene-conjugated diene copolymer, the UV absorber, and the light stabilizer are as described above. Other additives, such as those described above, can also be included in the composition.

In the combining step, the monovinylarene-conjugated diene copolymer, the UV absorber, the light stabilizer, and other additives, if any, are combined to form the composition. Any appropriate combining technique can be used. In one embodiment, the combining step involves melt-blending, that is, heating the monovinylarene-conjugated diene copolymer, the UV absorber, the light stabilizer, and other additives, if any to a temperature sufficiently high for the monovinylarene-conjugated diene copolymer to melt and provide a continuous liquid phase in which other components can be mixed or are miscible. Thereafter, the composition can be cooled for storage, or can be fed to a process for fabricating a structure from the composition, among other possibilities. Alternatively or in addition, solution blending or coextrusion, among other techniques, can be used in the combining step.

In one embodiment, the combining step involves the forming of a tumbled blend. In one embodiment, a tumbled blend can be formed by mixing monovinylarene-conjugated diene copolymer pellets with about 1 wt part mineral oil per 100 wt parts copolymer in a drum. By rotating the drum, the mineral oil can be distributed over the greater portion of the pellets' surfaces. Thereafter, the UV absorber, the light stabilizer, and any other desired additives can be provided as solids, such as powders, to the drum. By further rotating the drum, the UV absorber, the light stabilizer, and any other additives can be dispersed and “stuck” to the oily regions of the pellets' surfaces.

The UV absorber and the light stabilizer can be provided as a concentrate in the form of a powder, a pellet, or any other known form, and an appropriate amount of the concentrate can be added to the monovinylarene-conjugated diene copolymer in the combining step.

In another embodiment, the present invention relates to a method of fabricating a UV-stabilized monovinylarene-conjugated diene copolymer article, comprising:
forming a composition comprising (i) at least about 5 wt % of a monovinylarene-conjugated diene copolymer; (ii) from about 0.1 wt % to about 2.5 wt % of an ultraviolet (UV) absorber; and (iii) from about 0.1 wt % to about 2.5 wt % of a light stabilizer into the article or a component thereof.

The composition is as described above, and can be formed by the method described above.

In one embodiment, the UV absorber is present from about 0.3 wt % to about 0.6 wt % of the composition. In one embodiment, the light stabilizer is present from about 0.4 wt % to about 0.6 wt % of the composition.

An “article,” as used herein, is any product which can be formed, in whole or in part, from the composition. An article partially formed from the composition can be an article containing a layer formed from the composition or an article having a lid or wrap formed from the composition, among others. Examples of such products include, but are not limited to, containers, medical packaging, medical devices, toys, garment hangers, and flexible and rigid packaging, among others.

In the forming step, the composition can be formed into the article or a component thereof by any appropriate technique. Examples of appropriate techniques include, but are not limited to, sheet extrusion, thermoforming, injection molding, blow molding, film blowing, and film casting, among others. Selection of a forming technique is a matter of routine experimentation for the skilled artisan having the benefit of the present disclosure.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES 1-16

### Yellowing Resistance of Styrene-Butadiene Copolymer/UV Absorber/HALS Compositions

A series of monovinylarene/conjugated diene copolymer compositions (and one polycarbonate composition, as a positive control) were prepared and fabricated into injection molded optical discs (125 mil thick), and the optical discs then underwent accelerated aging in a Xenon Arc Weatherometer under the following conditions: Length of test, 156 days. Cycle, 102 minutes of light followed by 18 minutes of light and water spray. UV energy level, 0.35 W/m² at 340 nm. Black Panel Temperature, 63° F.

The samples were pulled every 26 days and tested for color change on a standard colorimeter. Coloring was scored in Hunter b units.

The length of the test was chosen on the assumption that 156 days in the weatherometer corresponds to approximately 3 years of outdoor exposure in the southern continental United States (e.g., Florida).

The compositions are given in Table 1.

TABLE 1

| Example | Composition |
|---|---|
| 1 | 100% KR03 (Negative Control) |
| 2 | LEXAN PC 153 2.5 MF (Positive Control) |
| 3 | KR03/0.3% CIBA TINUVIN 328/0.4% CIBA TINUVIN 770 |
| 4 | KR03/0.3% CIBA TINUVIN 328/0.4% CIBA TINUVIN 770/0.005% OB |
| 5 | KR03/0.3% CIBA TINUVIN 328/0.4% CIBA TINUVIN 770/0.005% BLUE TINT |
| 6 | KR03/0.3% CIBA TINUVIN P/0.4% CIBA TINUVIN 791 FB |
| 7 | KR03/0.3% CIBA TINUVIN 1577/0.4% CIBA TINUVIN 791 FB |
| 8 | KR03/0.3% CIBA TINUVIN P/0.4% CHIMASSORB 119 FL |
| 9 | KR03/0.3% CIBA TINUVIN 1577/0.4% CHIMASSORB 119FL |
| 10 | KR03/0.3% CHIMASSORB 81/0.4% CHIMASSORB 119FL |
| 11 | KR03/0.3% CIBA TINUVIN 328/0.4% CIBA TINUVIN 765 |
| 12 | KR03/0.3% CIBA TINUVIN 1577/0.4% CIBA TINUVIN 765 |
| 13 | KR03/0.3% CIBA TINUVIN P/0.4% CIBA TINUVIN 765 |
| 14 | KR03/0.3% GREAT LAKES LOWILITE 28/0.4% GREAT LAKES LOWILITE 77 |
| 15 | KR03/0.3% GREAT LAKES LOWILITE 55/0.4% GREAT LAKES LOWILITE 77 |
| 16 | KR03/0.3% GREAT LAKES LOWILITE 28/0.4% GREAT LAKES LOWILITE 77/0.3% |
| | ANOX PP18 |

“KR03” refers to a styrene-butadiene copolymer commercially available from Chevron Phillips Chemical Co. (The Woodlands, TX).
“Lexan PC 153 2.5 MF” refers to a polycarbonate commercially from GE Plastics (Pittsfield, MA).
“Tinuvin 328” refers to 2-(2H-benzotriazol-2-yl)-4,6-ditertpentylphenol, commercially available from Ciba Specialty Chemicals (Basel, Switzerland).
“Tinuvin 770” refers to Bis(2,2,6,6-tetramethyl-4-piperidyl)sebacate, commercially available from Ciba Specialty Chemicals (Basel, Switzerland).
“OB” refers to a commercially-available optical brightener.
“Blue Tint” refers to a commercially-available blue and violet pigment that retained the transparency of the structure.
“Tinuvin P” refers to 2-(2′-hydroxy-5′-methylphenyl)benzotriazole, commercially available from Ciba Specialty Chemicals (Basel, Switzerland).
“Tinuvin 791 FB” refers to a HALS commercially available from Ciba Specialty Chemicals (Basel, Switzerland).
“Tinuvin 1577” refers to 2-(4,6-diphenyl-1,3,5-triazin-2-yl)-5-(hexyl)oxylphenol, commercially available from Ciba Specialty Chemicals (Basel, Switzerland).
“Chimassorb 119 FL” refers to a HALS commercially available from Ciba Specialty Chemicals (Basel, Switzerland).
“Chimassorb 81” refers to a UV absorber commercially available from Ciba Specialty Chemicals (Basel, Switzerland).
“Tinuvin 765” refers to a HALS comprising bis(1,2,2,6,6-pentamethyl-4-pipderidyl)sebacate and methyl 1,2,2,6,6-pentamethyl-4-pipderidyl sebacate commercially available from Ciba Specialty Chemicals (Basel, Switzerland).
“Lowilite 28” and “Lowilite 55” refer to benzotriazole UV absorbers, commercially available from Great Lakes Chemical (Indianapolis, IN).
“Lowilite 77” refers to a HALS commercially available from Great Lakes Chemical (Indianapolis, IN).
“Anox PP18” refers to a hindered phenolic antioxidant commercially available from Great Lakes Chemical (Indianapolis, IN).

Yellowing was measured using colorimeter, as described above, at day 0 and various other times. Results, as Hunter b values at various days and as Δ Hunter b over the course of the run (Hunter b_{day 156}−Hunterb_{day 0}), are shown in Table 2, with greater values indicating more yellowing of the structures.

TABLE 2

| | | 26 | 52 | 78 | 104 | 130 | 156 | Δ Hunter b |
|---|---|---|---|---|---|---|---|---|
| Example | 0 DAYS | DAYS | DAYS | DAYS | DAYS | DAYS | DAYS | (day 156 − day 0) |
| 1 | 2.12 | 8.51 | 16.62 | 27.52 | 32 | 31.5 | 32.71 | 30.59 |
| 2 | 0.11 | 1.26 | 2.3 | 6.24 | 7.97 | 9.13 | 10.56 | 10.45 |
| 3 | 2.97 | 2.93 | 4.52 | 7.68 | 12.47 | 15.46 | 17.72 | 14.75 |
| 4 | 2.06 | 7.02 | 9.57 | 13.67 | 21.08 | 24.39 | 26.11 | 24.05 |
| 5 | −2.82 | −2.27 | −0.97 | 1.58 | 3.7 | 6.53 | 10.03 | 12.85 |
| 6 | 3.71 | 4.99 | 7.43 | 10.06 | 17.2 | 18.89 | 22.36 | 18.65 |
| 7 | 4.88 | 4.3 | 5.45 | 7.34 | 10.98 | 15.13 | 18.28 | 13.4 |
| 8 | 3.65 | 3.07 | 4.8 | 9.29 | 17.7 | 18.86 | 22.64 | 18.99 |
| 9 | 3.08 | 3.57 | 4.13 | 6.02 | 11.89 | 14.79 | 18.5 | 15.42 |
| 10 | 4.03 | 3.05 | 5.77 | 12.29 | 18.24 | 16.73 | 19.83 | 15.8 |
| 11 | 3.35 | 2.38 | 3.76 | 4 | 5.36 | 8.28 | 10.97 | 7.62 |
| 12 | 3.15 | 3.4 | 3.58 | 4.69 | 5.21 | 6.86 | 8.28 | 5.13 |
| 13 | 4.29 | 4.35 | 7.06 | 10.28 | 15.55 | 18.07 | 21.25 | 16.96 |
| 14 | 3.31 | 3.03 | 3.8 | 5.52 | 7.09 | 8.96 | 12.48 | 9.17 |
| 15 | 2.86 | 3.38 | 5.17 | 7.14 | 10.96 | 15.29 | 17.65 | 14.79 |
| 16 | 3.1 | 3.02 | 3.76 | 5.69 | 7.29 | 10.3 | 13.69 | 10.59 |

Example 1, a styrene-butadiene copolymer composition without a UV absorber and a HALS reached a high degree of yellowing (Δ Hunter b greater than about 25) by day 78. In contrast, Example 2, a polycarbonate composition, reached a moderate degree of yellowing (Δ Hunter b between about 10 and about 15) by day 156.

Of the styrene-butadiene copolymer compositions containing both a UV absorber and a HALS (Examples 3-16), all exhibited yellowing resistance relative to Example 1 (defined as either reaching a high degree of yellowing (Δ Hunter b greater than about 25) later than day 78 or only reaching a moderate degree of yellowing (Δ Hunter b between about 10 and about 15) by day 156). Two styrene-butadiene copolymer compositions, containing either KR03/0.3% Tinuvin 328/0.4% Tinuvin 765 (Example 11) or KR03/0.3% Tinuvin 1577/0.4% Tinuvin 765 (Example 12), reached only a low degree of yellowing (Δ Hunter b less than about 10) after 156 days.

These results indicate that the inclusion of both a UV absorber and a HALS can impart yellowing resistance to a monovinylarene-conjugated diene copolymer composition, and that particular UV absorbers and HALS can impart a yellowing resistance at least comparable to that scene in polycarbonates, which are known in the art to have commercially acceptable yellowing resistance.

All of the compositions and methods disclosed and claimed herein can be made and executed without undue experimentation in light of the present disclosure. While the compositions and methods of this invention have been described in terms of particular embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

1. A composition, comprising:
at least about 5 wt % of a monovinylarene-conjugated diene copolymer;
from about 0.1 wt % to about 2.5 wt % of an ultraviolet (UV) absorber; and
from about 0.1 wt % to about 2.5 wt % of a light stabilizer; and
wherein the UV absorber further comprises 2-(2H-benzotriazol-2-yl)-4,6-ditertpentylphenol or 2-(4,6-diphenyl-1,3,5-triazin-2-yl)-5-hexyl)oxylphenol.

2. The composition of claim 1, wherein the light stabilizer is a hindered amine light stabilizer (HALS).

3. The composition of claim 1, comprising at least about 50 wt % of the monovinylarene-conjugated diene copolymer.

4. The composition of claim 1, comprising at least about 95 wt % of the monovinylarene-conjugated diene copolymer.

5. (canceled)

6. (canceled)

7. The composition of claim 1, comprising from about 0.3 wt % to about 0.6 wt % of the UV absorber.

8. The composition of claim 2, wherein the HALS comprises bis(1,2,2,6,6-pentamethyl-4-piperidyl)sebacate or methyl 1,2,2,6,6-pentamethyl-4-piperidyl sebacate.

9. The composition of claim 8, comprising from about 0.4 wt % to about 0.6 wt % of the HALS.

10. The composition of claim 1, further comprising a styrene/methyl methacrylate or polystyrene.

11. A method of synthesizing a UV-stabilized monovinylarene-conjugated diene copolymer composition, comprising:
combining (i) at least about 5 wt % of a monovinylarene-conjugated diene copolymer, (ii) from about 0.1 wt % to about 2.5 wt % of an ultraviolet (UV) absorber; and (iii) from about 0.1 wt % to about 2.5 wt % of a light stabilizer, to form the composition.

12. The method of claim 11, wherein the light stabilizer is a hindered amine light stabilizer (HALS).

13. The method of claim 11, comprising from about 0.3 wt % to about 0.6 wt % of the UV absorber.

14. The method of claim 12, comprising from about 0.4 wt % to about 0.6 wt % of the HALS.

15. The method of claim 11, wherein the combining step comprises melt blending.

16. The method of claim 11, wherein the combining step comprises solution blending, coextrusion, or the forming of a tumbled blend.

17. A method of fabricating a UV-stabilized monovinylarene-conjugated diene copolymer article, comprising:
forming a composition comprising (i) at least about 5 wt % of a monovinylarene-conjugated diene copolymer; (ii) from about 0.1 wt % to about 2.5 wt % of an ultraviolet (UV) absorber; and (iii) from about 0.1 wt % to about 2.5 wt % of a light stabilizer into the article or a component thereof.

18. The method of claim 17, wherein the light stabilizer is a hindered amine light stabilizer (HALS).

19. The method of claim 17, wherein forming comprises sheet extrusion, thermoforming, injection molding, blow molding, film blowing, or film casting.
